(19) United States
(12) Patent Application Publication
(10) Pub. No.: US 2011/0216805 A1
(43) Pub. Date: Sep. 8, 2011

(54) DISSOLUTION TESTING WITH INFRARED TEMPERATURE MEASUREMENT

(76) Inventors: C.J. Anthony Fernando, Singapore (SG); Deon Smit, Cary, NC (US)

(21) Appl. No.: 12/716,157

(22) Filed: Mar. 2, 2010

(51) Int. Cl. G01K 1/14; G01J 5/00

(52) U.S. Cl. 374/121; 374/E01.018

(57) ABSTRACT

A dissolution test apparatus may include a vessel support member, a sensor support member, infrared temperature sensors, and an electronic controller. The vessel support member may have apertures for receiving vessels. The infrared temperature sensors are mounted at the sensor support member. Each infrared temperature sensor is positioned proximate to a respective vessel mounting site to receive infrared radiation emitted by media contained in a vessel mounted at the vessel mounting site, and is configured to transmit a measurement signal indicative of the temperature of the media. The electronic controller communicates with the infrared temperature sensors and is configured to receive and process the measurement signals transmitted from the infrared temperature sensors. The electronic controller may be configured to control media temperature in the vessels.

### FIELD OF THE INVENTION

The present invention relates generally to dissolution testing of analyte-containing media. More particularly, the invention relates to non-invasively measuring the temperature of media contained in test vessels of a dissolution test apparatus by utilizing infrared sensing techniques.

### BACKGROUND OF THE INVENTION

Dissolution testing is often performed as part of preparing and evaluating soluble materials, particularly pharmaceutical dosage forms (e.g., tablets, capsules, and the like) consisting of a therapeutically effective amount of active drug carried by an excipient material. Typically, dosage forms are dropped into test vessels that contain dissolution media of a predetermined volume and chemical composition. For instance, the composition may have a pH factor that emulates a gastro-intestinal environment. Dissolution testing can be useful, for example, in studying the drug release characteristics of the dosage form or in evaluating the quality control of the process used in forming the dose. To ensure validation of the data generated from dissolution-related procedures, dissolution testing is often carried out according to guidelines approved or specified by certain entities such as United States Pharmacopoeia (USP), in which case the testing must be conducted within various parametric ranges. The parameters may include dissolution media temperature, the amount of allowable evaporation-related loss, and the use, position and speed of agitation devices, dosage-retention devices, and other instruments operating in the test vessel.

As a dosage form is dissolving in the test vessel of a dissolution system, optics-based measurements of samples of the solution may be taken at predetermined time intervals through the operation of analytical equipment such as a spectrophotometer. The analytical equipment may determine analyte (e.g. active drug) concentration and/or other properties. The dissolution profile for the dosage form under evaluation—i.e., the percentage of analytes dissolved in the test media at a certain point in time or over a certain period of time—can be calculated from the measurement of analyte concentration in the sample taken. In one specific method employing a spectrophotometer, sometimes referred to as the sipper method, dissolution media samples are pumped from the test vessel(s) to a sample cell contained within the spectrophotometer, scanned while residing in the sample cell, and in some procedures then returned to the test vessel(s). In another more recently developed method, sometimes referred to as the in situ method, a fiber-optic “dip probe” is inserted directly in a test vessel. The dip probe includes one or more optical fibers that communicate with the spectrophotometer. In the in situ technique, the spectrophotometer thus does not require a sample cell as the dip probe serves a similar function. Measurements are taken directly in the test vessel and thus optical signals rather than liquid samples are transported between the test vessel and the spectrophotometer via optical fibers.

During the course of dissolution testing, it is desirable and often required to measure the temperature of media residing in the vessels of the dissolution test apparatus. Conventionally, in situ temperature probes of various designs (thermocouples, thermistors, etc.) have been utilized for this purpose. Such temperature probes are inserted either manually or by mechanized means into the vessels. A primary problem attending the use of temperature probes is their contribution to hydrodynamic disturbances with the vessels that can result in significant analytical errors and noise adversely affecting the dissolution data being acquired. For example, hydrodynamic disturbances such as flow aberrations and turbulence can affect the release rate of the dosage formulation being tested. To reduce the deleterious effects of hydrodynamic disturbances, temperature probes may be submerged in the media of the test vessel only during limited periods of time to make discrete measurements of temperature and thereafter removed from the media. However, the physical act of inserting the temperature probes into the media or thereafter removing the temperature probes from the media can itself cause transient hydrodynamic disturbances and eliminates the ability to monitor media temperature continuously or in real time. Moreover, cycling temperature probes into and out from the media by manual means is laborious and time-consuming, and by automated means requires costly drive components that are subject to failure. Moreover, temperature probes of conventional design require physical contact with the media and time to equilibrate or stabilize, and their accuracy and response time to generate measurement signals is less than optimal.

Accordingly, there is a need for methods and apparatus for accurately and quickly measuring media temperature during dissolution testing by non-invasive or ex situ means, and with the option of doing so on a real-time basis, without affecting performance of either the dissolution test apparatus or the temperature measurement devices utilized in conjunction with the dissolution test apparatus.

### SUMMARY OF THE INVENTION

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, dissolution test apparatus is provided. The dissolution test apparatus may include a vessel support member, a sensor support member, a plurality of infrared temperature sensors, and an electronic controller. The vessel support member includes a plurality of vessel mounting sites for supporting a plurality of vessels. Each vessel mounting site has an aperture for receiving a vessel. The sensor support member is disposed proximate to the vessel mounting sites. The infrared temperature sensors are mounted at the sensor support member. Each infrared temperature sensor is positioned proximate to a respective vessel mounting site to receive infrared radiation emitted by media contained in a vessel mounted at the aperture, and is configured to transmit a measurement signal indicative of the temperature of the media. The electronic controller communicates with the infrared temperature sensors and is configured to receive and process the measurement signals transmitted from the infrared temperature sensors.

According to another implementation, each infrared temperature sensor is positioned below a respective vessel mounting site and proximate to a side of a respective vessel mounted at the vessel mounting site to receive infrared radiation emitted by the media at the side of the vessel.

According to another implementation, further including a plurality of vessels mounted at the respective apertures, each vessel including an infrared-transmitting window aligned with a respective infrared temperature sensor.

According to another implementation, the sensor support member or the infrared temperature sensors are positioned proximate to the apertures.

According to another implementation, the dissolution test apparatus further includes means for acquiring dissolution data from the media contained in the vessels of the dissolution test apparatus.

According to another implementation, a method is provided for measuring temperature of dissolution media contained in respective vessels of a dissolution test apparatus. The method may include the following. A plurality of vessels is inserted through respective apertures of a vessel support member of the dissolution test apparatus. A sensor support member is positioned proximate to the vessels such that a plurality of infrared temperature sensors supported by the sensor support member are positioned proximate to respective interiors of the vessels without being submerged in volumes of dissolution media respectively contained in the vessels. The respective volumes of dissolution media are heated. The temperatures of the respective volumes of dissolution media are non-invasively monitored by operating the infrared temperature sensors to receive infrared radiation emitted from the respective volumes of dissolution media, generating measurement signals indicative of the temperatures of the respective volumes of dissolution media, and transmitting the measurement signals to an electronic controller of the dissolution test apparatus.

According to another implementation, the method includes positioning a sensor support member proximate to upper openings of the vessels.

According to another implementation, the method further includes controlling the temperatures of the volumes of media based on the transmitted measurement signals by controlling one or more heating devices.

According to another implementation, the method further includes introducing dosage forms into the vessels, dissolving the dosage forms in the respective volumes of media, and acquiring dissolution data from the media while the dosage forms are being dissolved, wherein monitoring the temperatures occurs while the dissolution data are being acquired.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a perspective view of an example of a dissolution test apparatus to which the subject matter taught in the present disclosure may be applied.

FIG. 2 is a perspective view of another example of a dissolution test apparatus to which the subject matter taught in the present disclosure may be applied.

FIG. 3 is a cross-sectional elevation view of an example of a vessel mounting site of a dissolution test apparatus, with an infrared temperature sensor positioned to measure media temperature, according to an implementation taught in the present disclosure.

FIG. 4 is a cross-sectional elevation view of another example of a vessel mounting site of a dissolution test apparatus, with an infrared temperature sensor positioned to measure media temperature, according to an implementation taught in the present disclosure.

FIG. 5 is a cross-sectional elevation view of another example of a vessel mounting site of a dissolution test apparatus, with an infrared temperature sensor positioned to measure media temperature, according to an implementation taught in the present disclosure.

FIG. 6 is a cross-sectional elevation view of another example of a vessel mounting site of a dissolution test apparatus, with an infrared temperature sensor positioned to measure media temperature, according to an implementation taught in the present disclosure.

FIG. 7 is a schematic view of an example of a temperature measurement processing system according to an implementation taught in the present disclosure.

FIG. 8 is a schematic view of an example of an analytical system to which the subject matter taught in the present disclosure may be applied.

FIG. 9 is a cross-sectional elevation view of another example of a vessel mounting site of a dissolution test apparatus, with an infrared temperature sensor positioned to measure media temperature, according to another implementation taught in the present disclosure.

### DETAILED DESCRIPTION OF THE INVENTION

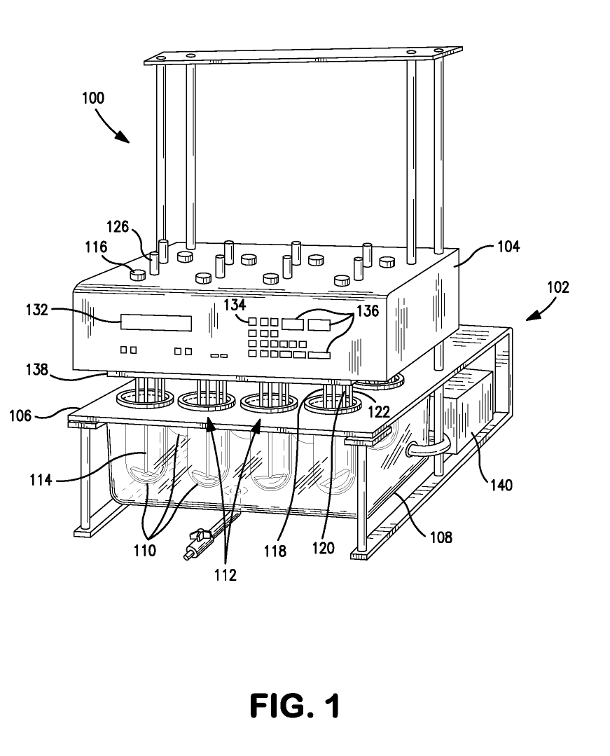

FIG. 1 is a perspective view of an example of a dissolution test apparatus 100 according to an implementation of the present disclosure. The dissolution test apparatus 100 may include a frame assembly 102 supporting various components such as a main housing, control unit or head assembly 104, a vessel support member (e.g., a plate, rack, etc.) 106 below the head assembly 104, and a water bath container 108 below the vessel support member 106. The vessel support member 106 supports a plurality of vessels 110 extending into the interior of the water bath container 108 at a plurality of vessel mounting sites 112. FIG. 1 illustrates eight vessels 110 by example, but it will be understood that more or less vessels 110 may be provided. The vessels 110 are typically locked and centered in place on the vessel support member 106 by means such as ring lock devices or clamps (not shown). Alternatively, the vessels 110 themselves may be configured to have centering capability, as disclosed for example in U.S. Pat. Nos. 6,562,301 and 6,673,319, assigned to the assignee of the present disclosure. Vessel covers (not shown) may be provided to prevent loss of media from the vessels 110 due to evaporation, volatility, etc. Optionally, the vessel covers may be coupled to the head assembly 104 and movable by motorized means into position over the upper openings of the vessels 110, as disclosed for example in U.S. Pat. No. 6,962,674, assigned to the assignee of the present disclosure. Water or other suitable heat-carrying liquid medium may be heated and circulated through the water bath container 108 by means such as an external heater and pump module 140, which may be included as part of the dissolution test apparatus 100.

The head assembly 104 may include mechanisms for operating or controlling various components that operate in the vessels 110 (in situ operative components). For example, the head assembly 104 typically supports stifling elements 114 that include respective motor-driven spindles and paddles operating in each vessel 110. Individual clutches 116 may be provided to alternately engage and disengage power to each stifling element 114 by manual, programmed or automated means. The head assembly 104 also includes mechanisms for driving the rotation of the stifling elements 114. The head assembly 104 may also include mechanisms for operating or controlling media transport cannulas that provide liquid flow paths between liquid lines and corresponding vessels 110. The media transport cannulas may include media dispensing cannulas 118 for dispensing media into the vessels 110 and media aspirating cannulas 120 for removing media from the vessels 110. The head assembly 104 may also include mechanisms for operating or controlling other types of in situ operative components 122 such as fiber-optic probes for measuring analyte concentration, pH detectors, dosage form holders (e.g., USP-type apparatus such as baskets, nets, cylinders, etc.), video cameras, etc. A dosage delivery module 126 may be utilized to preload and drop dosage units (e.g., tablets, capsules, or the like) into selected vessels 110 at prescribed times and media temperatures. Additional examples of mechanisms for operating or controlling various in situ operative components are disclosed for example in above-referenced U.S. Pat. No. 6,962,674.

The head assembly 104 may include a programmable systems control module for controlling the operations of various components of the dissolution test apparatus 100 such as those described above. Peripheral elements may be located on the head assembly 104 such as an LCD display 132 for providing menus, status and other information; a keypad 134 for providing user-inputted operation and control of spindle speed, temperature, test start time, test duration and the like; and readouts 136 for displaying information such as RPM, temperature, elapsed run time, vessel weight and/or volume, or the like.

The dissolution test apparatus 100 may further include one or more movable components for lowering operative components 114, 118, 120, 122 into the vessels 110 and raising operative components 114, 118, 120, 122 out from the vessels 110. The head assembly 104 may itself serve as this movable component. That is, the entire head assembly 104 may be actuated into vertical movement toward and away from the vessel support member 106 by manual, automated or semi-automated means. Alternatively or additionally, other movable components 138 such as a driven platform may be provided to support one or more of the operative components 114, 118, 120, 122 and lower and raise the components 114, 118, 120, 122 relative to the vessels 110 at desired times.

One type of movable component may be provided to move one type of operative component (e.g., stirring elements 114) while another type of movable component may be provided to move another type of operative component (e.g., media dispensing cannulas 118 and/or media aspirating cannulas 120). Moreover, a given movable component may include means for separately actuating the movement of a given type of operative component 114, 118, 120, 122. For example, each media dispensing cannula 118 or media aspirating cannula 120 may be movable into and out from its corresponding vessel 110 independently from the other cannulas 118 or 120.

The media dispensing cannulas 118 and the media aspirating cannulas 120 communicate with a pump assembly (not shown) via fluid lines (e.g., conduits, tubing, etc.). The pump assembly may be provided in the head assembly 104 or as a separate module supported elsewhere by the frame 102 of the dissolution test apparatus 100, or as a separate module located external to the frame 102. The pump assembly may include separate pumps for each media dispensing line and/or for each media aspirating line. The pumps may be of any suitable design, one example being the peristaltic type. The media dispensing cannulas 118 and the media aspirating cannulas 120 may constitute the distal end sections of corresponding fluid lines and may have any suitable configuration for dispensing or aspirating liquid (e.g., tubes, hollow probes, nozzles, etc.). In the present context, the term “cannula” simply designates a small liquid conduit of any form that is insertable into a vessel 110.

In a typical operation, each vessel 110 is filled with a predetermined volume of dissolution media by pumping media to the media dispensing cannulas 118 from a suitable media reservoir or other source (not shown). One of the vessels 110 may be utilized as a blank vessel and another as a standard vessel in accordance with known dissolution testing procedures. Dosage units are dropped either manually or automatically into one or more selected media-containing vessels 110, and each stifling element 114 (or other agitation or USP-type device) is rotated within its vessel 110 at a predetermined rate and duration within the test solution as the dosage units dissolve. In other types of tests, a cylindrical basket or cylinder (not shown) loaded with a dosage unit is substituted for each stifling element 114 and rotates or reciprocates within the test solution. For any given vessel 110, the temperature of the media may be maintained at a prescribed temperature (e.g., approximately 37+/−0.5° C.) if certain USP dissolution methods are being conducted. The mixing speed of the stifling element 114 may also be maintained for similar purposes. Media temperature is maintained by immersion of each vessel 110 in the water bath of water bath container 108, or alternatively by direct heating as described previously. The various operative components 114, 118, 120, 122 provided may operate continuously in the vessels 110 during test runs. Alternatively, the operative components 114, 118, 120, 122 may be lowered manually or by an automated assembly 104 or 138 into the corresponding vessels 110, left to remain in the vessels 110 only while sample measurements are being taken at allotted times, and at all other times kept outside of the media contained in the vessels 110. In some implementations, submerging the operative components 114, 118, 120, 122 in the vessel media at intervals may reduce adverse effects attributed to the presence of the operative components 114, 118, 120, 122 within the vessels 110.

During a dissolution test, sample aliquots of media may be pumped from the vessels 110 via the media aspiration cannulas 120 and conducted to an analyzing device (not shown) such as, for example, a spectrophotometer to measure analyte concentration from which dissolution rate data may be generated. In some procedures, the samples taken from the vessels 110 are then returned to the vessels 110 via the media dispensing cannulas 118 or separate media return conduits. Alternatively, sample concentration may be measured directly in the vessels 110 by providing fiber-optic probes as appreciated by persons skilled in the art. After a dissolution test is completed, the media contained in the vessels 110 may be removed via the media aspiration cannulas 120 or separate media removal conduits.

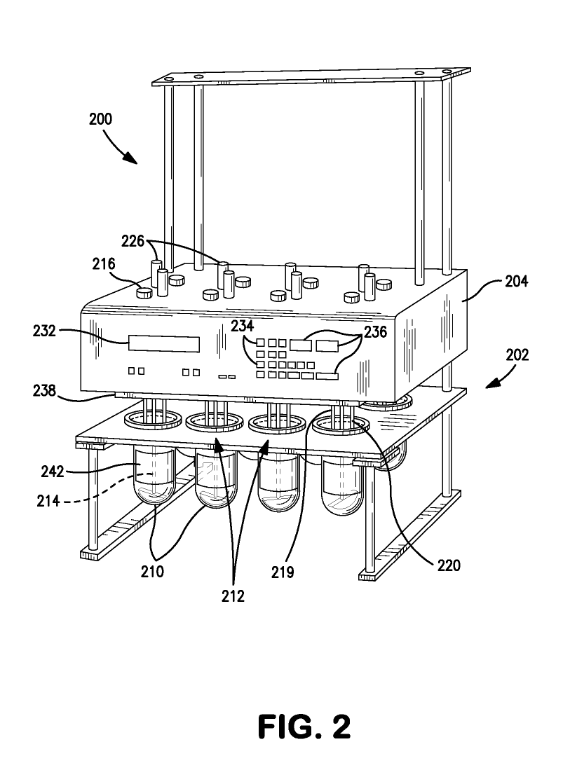

FIG. 2 is a perspective view of another example of a dissolution test apparatus 200 according to an implementation of the present disclosure. The dissolution test apparatus 200 may be configured and operate similarly to the dissolution test apparatus 100 illustrated in FIG. 1, and accordingly like reference numerals designate like components or features. In comparison to the dissolution test apparatus 100 illustrated in FIG. 1, the dissolution test apparatus 200 eliminates the need for the water bath container 108, the heater and pump module 140, and associated components. Instead, the dissolution test apparatus 200 provides a waterless or direct vessel heating design in which each vessel 210 is directly heated by some form of heating element 242 disposed in thermal contact with the wall of the vessel 210. By this configuration, the vessels 210 may be heated individually and directly by their respective heating elements 242 instead of being heated collectively by submersion in a water bath. In this manner, media temperature in each vessel 210 may be controlled independently of the other vessels 210. In one example, each heating element 242 is wrapped around the outer surface of a corresponding vessel 210 and may be adhered to the vessel 210 through the use of a pressure-sensitive or heat-activated adhesive. The heating element 242 may comprise a laminated structure that includes a plurality of thin films preferably constructed from a clear material. A heat conductive element such as one or more electrically resistive wires is embedded in one or more of the films, and supplies heat energy to the media contained in the vessel 210 to maintain the temperature of the media at a preset level. Each heating element 242 may include more than one separate heat conductive element to provide separately-controlled heating zones within the vessel 210. Additionally, a temperature-sensing element such as an RTD wire may also be embedded in one or more of the films to control temperature. Moreover, an embedded protective sensor such as thermistor may be provided to sense and prevent a runaway temperature event or other malfunction. Further examples of direct vessel heating techniques are disclosed for example in U.S. Pat. Nos. 6,303,909 and 6,727,480, assigned to the assignee of the present disclosure. As described below, implementations of the present disclosure provide infrared (IR) temperature sensors configured to monitor the media temperature in individual vessels very accurately and with very fast response time, and on a continuous or real-time basis if desired. The operation of the IR temperature sensors may eliminate the need for providing temperature-sensing elements and protective sensors with the heating elements, thereby reducing cost and complexity.

As evident from the foregoing, it is desirable and often necessary to measure the temperature of media in individual vessels. A user may desire to measure the temperature of media contained in a given vessel on a random or arbitrary basis (e.g., “spot checks”). In addition, the media temperature may need to be controlled and maintained at a predetermined constant level or according to a predetermined varied temperature profile in accordance with a particular testing protocol. Moreover, in the case of direct vessel heating, the media temperatures in separate vessels may need to be checked at arbitrary user-initiated times, monitored intermittently or continuously, and/or controlled at individual temperature levels. Conventional dissolution test apparatus have provided a temperature probe for such purposes. Temperature probes, however, must be submerged into the vessel media and thus produce hydrodynamic disturbances adverse to the acquisition of accurate dissolution data. As noted above in conjunction with FIG. 1, the temperature probe may be provided as an in situ operative component 122 that is alternately insertable into and removable from a vessel 110 along with other operative components 114, 118, 120. While the ability to periodically operate a temperature probe in a vessel can reduce hydrodynamic disturbances, it does not eliminate them altogether and may produce additional hydrodynamic disturbances from the repeated acts of inserting and removing. Moreover, real-time measurement of media temperature can only be accomplished by allowing a temperature probe to remain in the vessel at all times during a dissolution test.

To address the foregoing problems, a dissolution test apparatus such as the dissolution test apparatus 100 or 200 illustrated in FIG. 1 or 2, according to the present disclosure, provides infrared (IR) temperature sensors (not specifically shown in FIGS. 1 and 2). At least one IR temperature sensor may be provided for each vessel for which the measurement of media temperature is desired. The IR temperature sensors may be positioned at or proximate to the vessel mounting sites so as to receive infrared radiation emitted from the liquid surfaces. As examples, the IR temperature sensors may be positioned below the vessel mounting sites (i.e., below the apertures of a vessel support member at which vessels are mounted), or at or proximate to respective sidewalls of the vessels, so as to receive infrared radiation emitted from the boundary of the media adjacent to the sidewall. Alternatively, the IR temperature sensors may be positioned at or proximate to upper openings of the vessels, and above the respective upper liquid surfaces contained in the vessels. In the present context, the terms “at” or “proximate to” mean that the distal ends of the IR temperature sensors may be positioned near a lateral wall or sidewall of a vessel, or at an elevation co-planar or substantially co-planar with the upper vessel openings, or above the upper vessel openings and thus outside the vessels, or below the upper vessel openings and thus inside the vessels. The exact elevation of an IR temperature sensor relative to a vessel may depend on the elevation of the liquid surface within the vessel, and/or a particular attribute of the IR temperature sensor such as its distance-to-spot (D:S) ratio as appreciated by persons skilled in the art. The IR temperature sensors may be provided in a fixed position relative to the vessels, which fixed position may be removable and/or adjustable, or may be movable toward and away from the vessels by manual, automated or semi-automated means. For example, the respective sensing heads of the IR temperature sensors may be mounted to the ends of drive mechanisms, such as may be represented by the elongate component 122 illustrated in FIG. 1. In other examples, the IR temperature sensors may be supported by and movable with other types of movable components of the dissolution test apparatus 100 or 200, such as the movable components 104 (204) and 138 (238). The IR temperature sensors communicate with circuitry that may be located in the head assembly 104 or 204 or elsewhere at the dissolution test apparatus 100 or 200. Such circuitry may be configured to display temperature readings, as well as to control media temperature through interaction with the heater and pump module 140 of a water-bath implementation or the vessel heating elements 242 of a direct vessel-heating implementation.

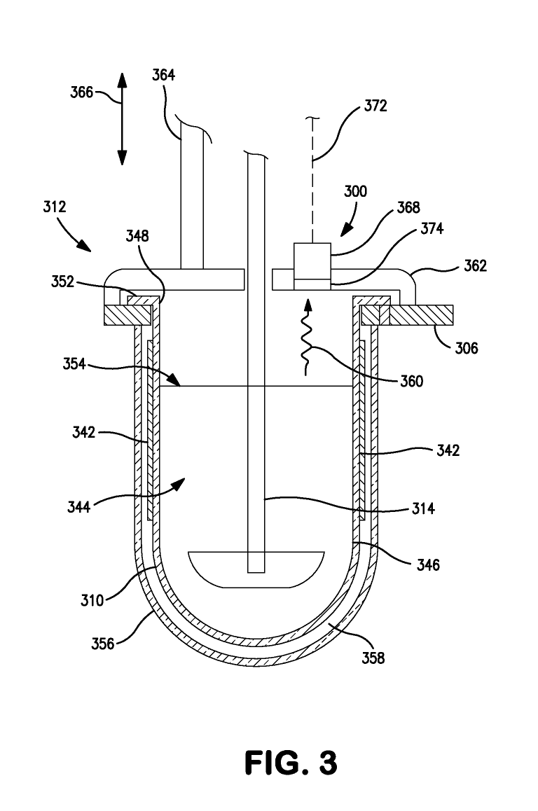

Additional examples of IR temperature sensors will now be described with reference to FIGS. 3-9.

FIG. 3 is a cross-section elevation view of an example of an IR temperature sensor 300 positioned at a vessel mounting site 312 so as to measure the temperature of media 344 contained in a vessel 310, according to one implementation. As described above, the vessel mounting site 312 and corresponding vessel 310 may be provided by a suitable dissolution test apparatus. The dissolution test apparatus typically includes a plurality of such vessel mounting sites 312 and corresponding vessels 310. The vessel mounting sites 312 are formed by a vessel support member 306 of the dissolution test apparatus such as described above and illustrated in FIG. 1. In the present example, the vessel 310 may include a main body 346 terminating at an upper opening 348. A flanged region 352 (e.g., rim, flange, etc.) of the vessel 310 is located at the upper opening 348 and is supported by the vessel support member 306. The flanged portion 352 may be integrally formed with the main body 346 of the vessel 310 as shown in FIG. 3. Alternatively, the vessel 310 may have a two-piece construction in which the flanged portion 352 is provided as a collar or ring that is secured to the main body 346 of the vessel 310, as described elsewhere in this disclosure. As also described elsewhere, the vessel support member 306 may also include means (not shown) for locking and centering each vessel 310 in place at the corresponding vessel mounting site 342. Also illustrated in FIG. 3 is a stifling element 314 operating in the vessel 310, a portion of which is submerged below a liquid surface 354 of the media 344. As noted above, other in situ operative components may also be inserted in the vessel 310. FIG. 3 also illustrates the option of providing direct vessel heating, and thus illustrates a heating element 342 secured around the main body 346 of the vessel 310 in thermal contact therewith. The vessel 310 may also be enclosed by a vessel isolation chamber 356 that provides a thermally insulating gap 358.

To properly position the IR temperature sensor 300 over the liquid surface 354 of the vessel interior so as to adequately receive IR emissions 360 from the media 344, the IR temperature sensor 300 is mounted at a sensor support member 362. In the example illustrated in FIG. 3, the vessel support member 362 is provided with, or forms a part of, a vessel cover. The vessel cover may include one or more openings to accommodate the stifling element 314 and/or other in situ operative components. The vessel cover may be supported on the flanged portion 352 of the vessel 310 or, as illustrated, on the vessel support member 306. If supported on the vessel support member 306, the vessel cover may be removably secured to the vessel support member 306 or simply rest thereon. The vessel cover may be fixed in position over the upper opening 348 of the vessel 310 by a user. Alternatively, the vessel cover may be mechanically referenced to a movable component of the dissolution test apparatus by means of a linkage or drive mechanism 364, and thereby movable toward and away from the vessel 310 as indicated by an arrow 366.

The IR temperature sensor 300 may have any design and physical size suitable for operating at a vessel mounting site 312 and receiving IR emissions 360 from liquid-phase media 344. The IR temperature sensor 300 may generally include a distal end or sensor head 368 containing a transducer device that converts IR emissions 360 into proportional electrical signals, as well as other electronics and devices as needed for performing its IR-based temperature-sensing functions. The IR temperature sensor 300 transmits its measurement signals to IR temperature sensing circuitry (not shown) via a wired or wireless transmission 372. The IR temperature sensing circuitry may be provided by the dissolution test apparatus, such as with the head assembly 104 or 204 or some other control unit supported elsewhere by the frame assembly 102 or 202 illustrated in FIGS. 1 and 2. A barrier 374 constructed of an IR-transmitting material may be provided by the sensor support member 362 (in this example, the vessel cover) or the IR temperature sensor 300 to protect the internal components of the IR temperature sensor 300 from moisture, contaminants, and impacts.

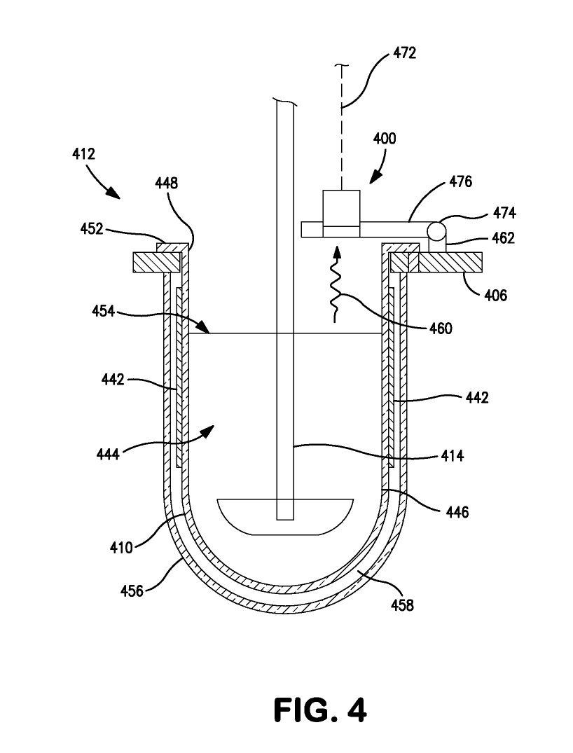

FIG. 4 is a cross-section elevation view of an example of an IR temperature sensor 400 positioned at a vessel mounting site 412 according to another implementation. In comparison to FIG. 3, like reference numerals designate like components. In this example, the sensor support member 462 is provided in the form of a small structural member such as a plate or rod that is suspended over the aperture of the vessel mounting site 412 and thus over the upper opening 448 of the vessel 410 mounted at the aperture. The dimensions of the sensor support member 462 may be minimized to serve the purpose of supporting the IR temperature sensor 400 in a proper position while not interfering the other components that may be operating at the vessel mounting site 412. The sensor support member 462 may be attached to the vessel support member 406 as illustrated, or alternatively may be attached to the flanged portion 452 of the vessel 410. The sensor support member 462 may be a permanent fixture of the vessel support member 406 or the flanged portion 452, or may be removably attached to either the vessel support member 406 or the flanged portion 452. The sensor support member 462 may include a hinge or pivot 474 that enables a movable portion 476 of the sensor support member 462 that houses the IR temperature sensor 400 to be rotated out of the way of the aperture of the vessel support member 406 and the vessel upper opening 448. Alternatively, the hinge or pivot 474 may be oriented to enable the IR temperature sensor 400 to be swung relative to the vertical axis. Alternatively, the movable portion 476 may be configured to slide along one or more directions to enable adjustment of the IR temperature sensor 400 relative to the vessel 410.

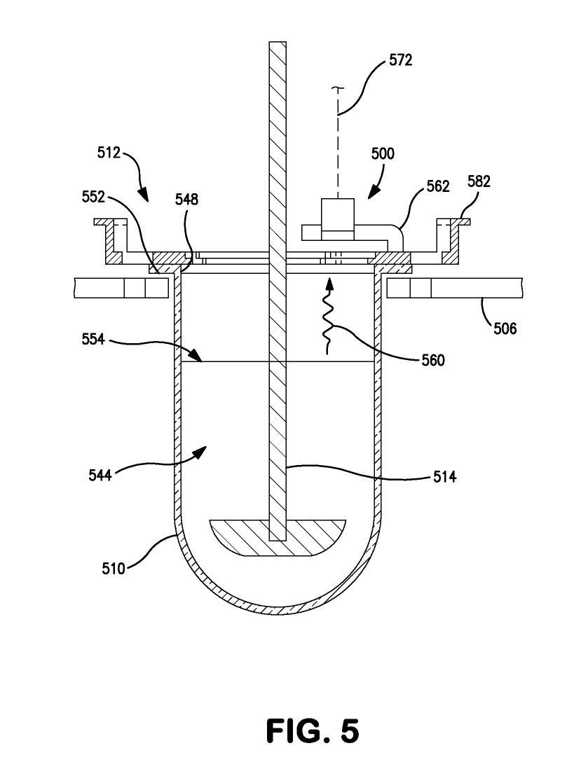

FIG. 5 is a cross-section elevation view of an example of an IR temperature sensor 500 positioned at a vessel mounting site 512 according to another implementation. In comparison to FIGS. 3 and 4, like reference numerals designate like components. In this example, a ring 582 interacts with the vessel support member 506 to lock and/or center the vessel 510 in the proper position at the vessel mounting site 512, as appreciated by persons skilled in the art. In accordance with the present implementation, the sensor support member 562 is attached to or forms a part of this ring.

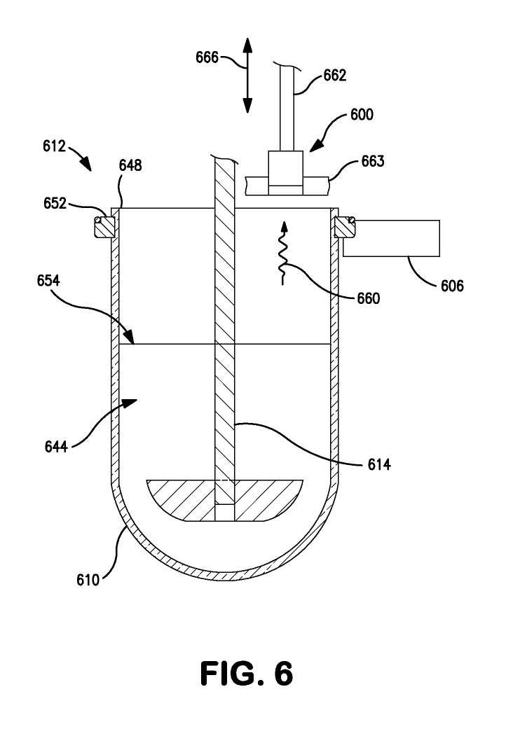

FIG. 6 is a cross-section elevation view of an example of an IR temperature sensor 600 positioned at a vessel mounting site 612 according to another implementation. In comparison to FIGS. 3-5, like reference numerals designate like components. In this example, the sensor support member is provided in the form of an elongate member 662 such as a shaft or rod that extends downwardly from a component of the dissolution test apparatus such as the head assembly 104 or 204 illustrated in FIGS. 1 and 2. The elongate member 662 may be hollow to contain the wire(s) utilized by the IR temperature sensor 600 to transmit measurement signals. In some implementations, the elongate member 662 may be movable toward and away from the vessel mounting site 612 and the IR temperature sensor 600 is accordingly movable therewith, as indicated by an arrow 666. As also illustrated in FIG. 6, instead of providing the elongate member 662, the vessel support member may be provided in the form of a movable platform 663. The movable platform 663 may also be utilized to move other operative components such as mentioned earlier in this disclosure.

FIG. 6 also illustrates that the vessel 610 may be provided as a two-part construction in which a collar or ring 652 is removably attached to the vessel 610 instead of providing an integrated flanged portion. The collar or ring 652 may be configured to provide a vessel centering function as noted earlier. A vessel 610 with a removable collar or ring 652 may be provided in any of the implementations illustrated in FIGS. 3-5. In one example, a sensor support member such as illustrated in FIG. 4 or 5 is attached to or forms a part of the collar or ring 652 illustrated in FIG. 6.

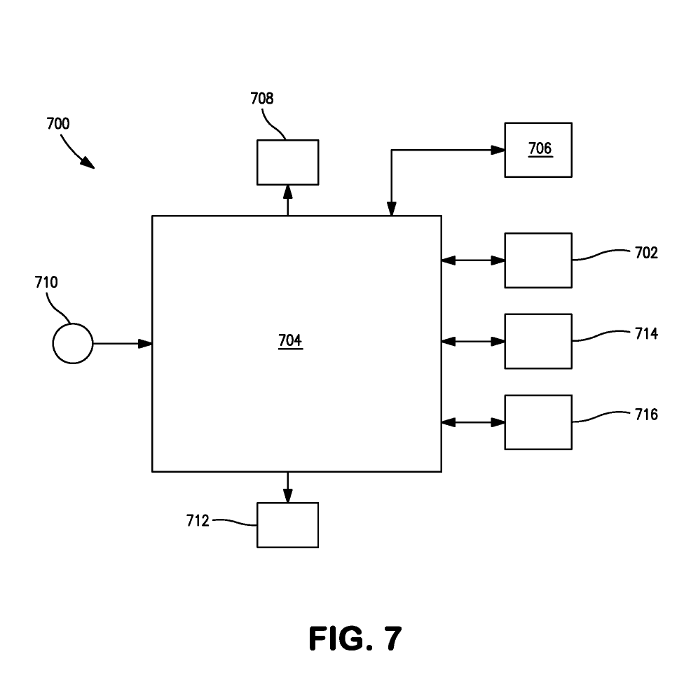

FIG. 7 is a general schematic diagram of an IR temperature measurement processing system 700 that may be provided with a dissolution test apparatus such as described above to interface with IR temperature sensors 702. The processing system 700 generally includes an electronic controller 704 that communicates with various other components via suitable electrical lines or other types of communication links. That is, in the present schematic context, the illustrated communication lines represent wires or other physical types of electrical conduits or, alternatively, wireless transmissions of electromagnetic signals. The processing system 700 may include circuitry for presenting readouts of media temperature values based on measurement signals received from the IR temperature sensors 702, and may also include vessel heating control circuitry. As appreciated by persons skilled in the art, the electronic controller 704 may be processor-based and include analog and/or digital attributes as well as hardware, firmware and/or software attributes. The processing system 700 may communicate with main control circuitry 706 of the dissolution testing apparatus over a dedicated communication link and hence can be housed within a suitable control unit of the dissolution testing apparatus such a head assembly 104 or 204 as illustrated by example in FIGS. 1 and 2.

The electronic controller 704 communicates with each IR temperature sensor 702 associated with each vessel and thus is able to monitor the temperatures of the respective volumes of media contained in each vessel. Because the IR temperature sensors 702 operate in a non-invasive manner, the electronic controller 704 may be configured to continuously monitor media temperatures in real time, thus providing temperature readouts and heater control on a real-time basis or any other temporal or event-driven basis desired by the user. In the illustrated example, the electronic controller 704 also communicates with a peripheral readout or display device 708 such as an LCD screen or the like that is configured to display temperature readings taken from the vessels, and may also display other information pertinent to the vessel heating process. In implementations providing control over the heating of media in the vessels, the electronic controller 704 may also communicate with a peripheral input device 710 such as a keypad for enabling user input of vessel media set point temperature and other appropriate system parameters for each vessel. In addition, the electronic controller 704 may communicate with one or more heating devices 712 utilized to heat the media contained in the vessels. In water-bath heating implementations, the heating device 712 may include a module interfacing with the water bath such as the heater and pump module 140 illustrated in FIG. 1. In this case, the electronic controller 704 operates the heating device 712 to regulate the temperature of the water bath and thus the temperature of media contained in all vessels. In direct-vessel heating implementations, the heating device 712 may include heat conductive elements respectively provided with heater elements 242 attached to the vessels as described above in conjunction with FIGS. 2-4. In this latter case, the electronic controller 704 independently operates the heating devices 712 associated with each vessel by controlling the power supplied thereto.

It will be noted that in prior direct-vessel heating implementations utilizing invasive temperature probes such as disclosed in above-referenced U.S. Pat. Nos. 6,303,909 and 6,727,480, an electronic controller was also utilized to power and receive signals from temperature sensing elements 714 and protective sensors 716 provided with the heater elements, 242 attached to the vessels. In the present implementation, however, the accuracy (e.g., +/−0.1° C.), reduced equilibration time, fast response time, and continuous operation of the IR temperature sensors 702 are such that the heater elements 242 may not need to include temperature sensing elements 714 or even protective sensors 716 and thus such components are optional in the present implementation.

In operation during a dissolution test, according to one example, the user operates the peripheral input device 710 to enter a set point temperature value, or a programmed temperature profile, according to which the media temperature in the vessels installed at the dissolution test apparatus is to be maintained. In direct vessel heating implementations, the user has the additional option of setting different operating temperatures for each vessel or each defined group of vessels. The electronic controller 704 controls the operation of the heating device(s) 712 to ensure that an appropriate amount of power is being provided to maintain media temperature(s) at the predetermined value(s). The IR temperature sensors 702 are moved into position relative to the vessels by manual or automated means as described by example above. The IR temperature sensors 702 measure and monitor media temperature in the vessels by generating measurement signals periodically, continuously, or according to some other user-defined temporal or event-driven basis as described above, and transmit the measurement signals to the electronic controller 704. In this manner, the electronic controller 704 is able to monitor the rise in media temperature in each vessel, determine whether the media temperature in a given vessel has stabilized at the previously inputted set point, and determine whether the media temperature has deviated from the set point or predetermined varying profile by greater than some predetermined error tolerance (e.g., +/−0.05° C.) over some predetermined period of time (e.g., 10 seconds). When vessel media temperature needs to be adjusted to correct for a deviation, or needs to vary according to a predetermined profile, the electronic controller 704 transmits appropriate control signals to the heating device(s) 712 so that an appropriate amount of heat energy is transferred to the media. The electronic controller 704 may also utilize the measurement signals received from the IR temperature sensors 702 to determine whether a heating device 712 has malfunctioned, such as by failing to heat a vessel or vessels or heating the vessel or vessels in an excessive or uncontrolled manner. If such alert conditions are detected, the electronic controller 704 may operated to shut the heating system 700 down.

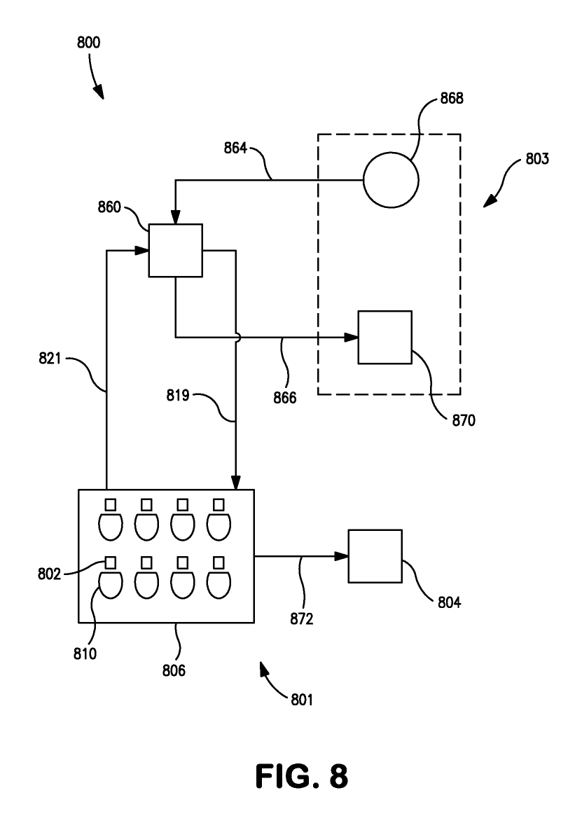

FIG. 8 is a schematic view of an analytical system 800 that generally includes a dissolution test apparatus 801 operating in conjunction with an analytical instrument 803 such as, for example, a spectrophotometer. The dissolution test apparatus 801 includes a plurality of vessels 810 mounted at a vessel support member 806 and a corresponding plurality of infrared temperature sensors 802 operatively positioned relative to the vessels 810 as described above. One or more media transport cannulas are insertable into each vessel 810. Such media transport cannulas may include media dispensing cannulas and media aspirating cannulas as described above. Each media dispensing cannula communicates with a suitable media dispensing line 819 and each media aspirating cannula communicates with a suitable media aspirating line 821. In the context of the present disclosure, such fluid lines 819 and 821 may represent one or more conduits, tubing, valves, manifolds, and other types of components utilized for liquid transport as appreciated by persons skilled in the art. In the present example, each pair of media dispensing and media aspirating lines 819 and 821 associated with a given vessel 810 communicates with a corresponding flow cell 860. The flow of media through each flow cell 860 is irradiated with a light beam to generate analytical signals from which analyte concentration, and thus dissolution data, may be derived. The light beams that propagate through the flow cells 860 may be routed through suitable optical components (e.g., optical fibers 864 and 866, lenses, etc.). The flow cells 860 are typically integrated with the analytical instrument 803, but alternatively may be integrated with the dissolution test apparatus 801 or located at some other location remote from the analytical instrument 803. As a further alternative, the flow cells 860 may be integrated with dip probes (not shown) that are inserted directly into the vessels 810 along with fiber-optics for routing light signals between the dip probes and the analytical instrument 803.

In the example illustrated in FIG. 8, the dissolution test apparatus 801 is configured to establish closed-loop liquid circuits associated with each vessel 810. For this purpose, the dissolution test apparatus 801 includes a pump assembly (not shown) that includes at least one pump communicating with a corresponding media dispensing line 819 or media aspirating line 821. Accordingly, in the present example, each closed-loop liquid circuit is defined by a vessel 810, a media aspirating line 821, a flow cell 860, a media dispensing line 819, and one or more pumps. As an alternative or in addition to communicating with the flow cells 860, the media dispensing line 819 may communicate with one or more sources (not shown) of dissolution media, solvents, reagents liquids for rinsing or washing, and the like Likewise, the media aspirating lines 821 may communicate with one or more liquid receptacles (not shown) such as waste receptacles, recovery tanks or reservoirs, etc. Additional fluid lines and pumps (not shown) may be provided for transporting liquid from sources to the vessels 810 and from the vessels 810 to receptacles.

The analytical instrument 803 may include one or more light sources 868 for transmitting light beams of an initial intensity to the flow cells 860 to irradiate the liquid media flowing therethrough, and one or more optical detectors 870 for receiving light beams from the flow cells 860 to determine the amount of attenuation of the light beam resulting from passage through the media in the flow cell 860. Examples of suitable light sources 868 include, but are limited to, one or more lamps (e.g., deuterium, xenon, etc.), LEDs, lasers or laser diodes (LDs), etc. Examples of suitable optical detectors 870 include, but are limited to, one or more photocells, photodiodes, etc. As appreciated by persons skilled in the art, the analytical instrument 803 may include appropriate means for routing optical signals between the flow cells 860 and the light source(s) 868 and the optical detector(s) 870 (e.g., optical switches, multiplexers, demultiplexers, optical fibers 864 and 866, light pipes, gratings, mirrors, etc.), as well as electronic processor-based control components, user interfaces, etc.

It will be understood that aspirated media may be transported to an analytical instrument 803 other than an optical cell-based instrument such as the spectrophotometer described by example above. Other examples of analytical instruments 803 include, but are not limited to, liquid or gas chromatographs, mass spectrometers, nuclear magnetic resonance spectrometers, fraction collectors, etc.

The dissolution test apparatus 801 further includes an IR temperature measurement processing system 804 such as described above in conjunction with FIG. 7. The processing system 804 may be integrated with the dissolution test apparatus 801 or situated remotely therefrom. The processing system 804 communicates with the IR temperature sensors 802 via suitable communication links 872. As described above, the processing system 804 may process signals received from the IR temperature sensors 802 according to any temporal basis or event-responsive basis, and such basis may be pre-programmed into the processing system or selected by the user. As examples, the processing system 804 may monitor the temperatures of vessel media on an essentially continuous or real-time basis or intermittently according to programmed or user-desired intervals. The measuring of media temperature may also be driven by events occurring or operations performed in one or more vessels 810, such as in response to the initiation or completion of a media dispensing step, the initiation or completion of a media aspirating step, or the initiation or completion of a full or partial dissolution testing procedure. The measuring of media temperature may also be performed to monitor media volume while an event is occurring such as media dispensing, media aspirating, and/or dissolution of a dosage form. The processing system 804 may also configured to display temperature values associated with one or more of the vessels 810 via a suitable display or readout device such as may be provided with the dissolution test apparatus 801. The processing system 804 may also interact with the analytical instrument 803 for various purposes, one example being the generation of media temperature data along with dissolution rate data.

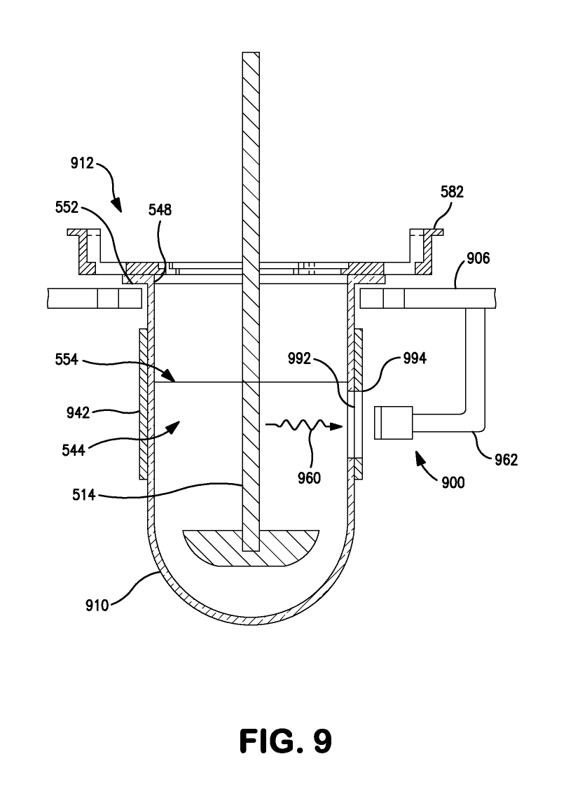

FIG. 9 is a cross-section elevation view of an example of an IR temperature sensor 900 positioned at a vessel mounting site 912 according to another implementation. In comparison to FIG. 5, like reference numerals designate like components, although it will be understood that the embodiment of FIG. 9 may be implemented in any of the embodiments shown in FIGS. 1-8. In this example, the sensor support member or component is provided in the form of an elongate member 962 such as a shaft or rod that extends downwardly from a vessel support member 906 or other suitable component of the dissolution test apparatus. The elongate member 962 may be hollow to contain the wire(s) utilized by the IR temperature sensor 900 to transmit measurement signals. In some implementations, the elongate member 962 may be movable toward and away from the vessel mounting site 912 so as to enable adjustment of the position of the IR temperature sensor 900 relative to the vessel 910. In FIG. 9, the IR temperature sensor 900 is thus positioned and oriented below the vessel mounting site 912 and below the vessel support member 906 and corresponding aperture, and proximate to the side (e.g., sidewall or lateral wall) of the vessel 910 so as to receive IR emissions 960 from a side or lateral boundary of the media 554 contained in the vessel 910, i.e., through the sidewall of the vessel 910. Software and/or circuitry provided with the system may be configured to compensate for any effects that IR transmission through the sidewall of the vessel 910 (and any other layers, e.g., insulating jacket, heating element, etc.) may have on the acquisition of the media temperature measurements. In this implementation, the vessel 910 may have any composition suitable for IR transmission (i.e., an IR-transmitting material), for example, borosilicate glass, Pyrex, etc. Additionally or alternatively, the vessel 910 may be provided with a window 992 specifically selected for IR transmission, such as for example sapphire, quartz, or various other glasses or crystals. Moreover, in a case where a heating element 942 is provided with the vessel 910, that heating element 942 may be provided with a window or opening 994 (i.e., an unobstructed area) to facilitate IR transmission to the heating element 942 to the IR temperature sensor 900. In comparison to other embodiments disclosed earlier in this disclosure, the configuration illustrated in FIG. 9 may be considered advantageous in that IR emissions 960 received by the IR temperature sensor 900 will not be affected by vapors rising from the top surface 554 of the media 544.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be further understood that various aspects or details of the invention may be changed without departing from the scope of the invention. Furthermore, the foregoing description is for the purpose of illustration only, and not for the purpose of limitation—the invention being defined by the claims.

What is claimed is:

1. A dissolution test apparatus, comprising:
a vessel support member comprising a plurality of vessel mounting sites for supporting a plurality of vessels, each vessel mounting site having an aperture for receiving a vessel;
a sensor support member disposed proximate to the vessel mounting sites;
a plurality of infrared temperature sensors mounted at the sensor support member, each infrared temperature sensor positioned proximate to a respective vessel mounting site to receive infrared radiation emitted by media contained in a vessel mounted at the aperture, and configured to transmit a measurement signal indicative of the temperature of the media; and
an electronic controller communicating with the plurality of infrared temperature sensors and configured to receive and process the measurement signals transmitted from the infrared temperature sensors.

2. The dissolution test apparatus of claim 1, wherein each infrared temperature sensor is positioned below a respective vessel mounting site and proximate to a side of a respective vessel mounted at the vessel mounting site to receive infrared radiation emitted by the media at the side of the vessel.

3. The dissolution test apparatus of claim 2, further comprising a plurality of vessels mounted at the respective apertures, each vessel comprising an infrared-transmitting window aligned with a respective infrared temperature sensor.

4. The dissolution test apparatus of claim 1, wherein the sensor support member comprises a plurality of vessel covers at which respective infrared temperature sensors are mounted, each vessel cover disposed at a respective aperture to cover an upper opening of a vessel mounted at the aperture.

5. The dissolution test apparatus of claim 1, wherein the sensor support member comprises a plurality of sensor support components at which respective infrared temperature sensors are mounted, each sensor support component extending over a respective aperture.

6. The dissolution test apparatus of claim 5, wherein each sensor support component is disposed on the vessel support member or on a flanged portion of a vessel mounted at the respective aperture.

7. The dissolution test apparatus of claim 5, wherein each sensor support component is a ring configured to engage the vessel support member and a vessel mounted at the respective aperture.

8. The dissolution test apparatus of claim 5, wherein each sensor support component comprises a movable portion at which respective infrared temperature sensors are mounted, and the movable portion is movable toward and away from the respective aperture to adjust a position of the infrared temperature sensor relative to the aperture.

9. The dissolution test apparatus of claim 1, further comprising a movable component positioned above the vessel support member and movable toward and away from the apertures, wherein the sensor support member is located at the movable component and is movable therewith.

10. The dissolution test apparatus of claim 1, wherein the electronic controller comprises circuitry for controlling the temperature of media contained in vessels mounted at the apertures based on the measurement signals received from the infrared temperature sensors.

11. The dissolution test apparatus of claim 10, further comprising a bath container into which vessels mounted at the respective apertures extend and a heating device communicating with the bath container, wherein the media temperature controlling circuitry communicates with the heating device.

12. The dissolution test apparatus of claim 10, further comprising a plurality of heating elements disposed in contact with respective vessels mounted at the apertures, wherein the media temperature controlling circuitry communicates with the heating elements.

13. The dissolution test apparatus of claim 12, wherein each infrared temperature sensor is positioned proximate to a respective side of a vessel to receive infrared radiation emitted by the media at the side, and each heating element comprises an opening aligned with a respective infrared temperature sensor.

14. A method for measuring temperature of dissolution media contained in respective vessels of a dissolution test apparatus, the method comprising:
inserting a plurality of vessels through respective apertures of a vessel support member of the dissolution test apparatus;
positioning a sensor support member proximate to the vessels such that a plurality of infrared temperature sensors supported by the sensor support member are positioned proximate to respective interiors of the vessels without being submerged in volumes of dissolution media respectively contained in the vessels;
heating the respective volumes of dissolution media; and
non-invasively monitoring the temperatures of the respective volumes of dissolution media by operating the infrared temperature sensors to receive infrared radiation emitted from the respective volumes of dissolution media, generating measurement signals indicative of the temperatures of the respective volumes of dissolution media, and transmitting the measurement signals to an electronic controller of the dissolution test apparatus.

15. The method of claim 14, wherein positioning the sensor support member comprises positioning each infrared temperature sensor below a respective aperture to receive infrared radiation emitted by the media at a side of the vessel mounted at the aperture.

16. The method of claim 14, wherein the sensor support member comprises a plurality of vessel covers at which respective infrared temperature sensors are mounted, and positioning the sensor support member comprises covering the upper openings of the vessels with respective vessel covers.

17. The method of claim 14, wherein the sensor support member comprises a plurality of sensor support components at which respective infrared temperature sensors are mounted, and positioning the sensor support member comprises positioning the sensor support components proximate to respective upper openings of the vessels.

18. The method of claim 14, wherein the sensor support member is coupled to the dissolution test apparatus, and positioning the sensor support member comprises operating the dissolution test apparatus to move the sensor support member toward the vessels.

19. The method of claim 14, wherein heating comprises operating a heating device to maintain a heated bath in contact with the vessels, and further comprising controlling the temperatures of the respective volumes of dissolution media based on the transmitted measurement signals by operating the electronic controller to control the heating device.

20. The method of claim 14, wherein heating comprises operating a plurality of heating elements in contact with the vessels, and further comprising controlling the temperatures of the respective volumes of dissolution media based on the transmitted measurement signals by operating the electronic controller to control the heating elements.
